(19) United States
(12) Patent Application Publication
(10) Pub. No.: US 2010/0008083 A1
(43) Pub. Date: Jan. 14, 2010

(54) Toy flashlight

(76) Inventor: Brownie Johnson, Kowloon (HK)

Correspondence Address: ALIX YALE & RISTAS LLP, 750 MAIN STREET, SUITE 1400, HARTFORD, CT, 06103, US

(21) Appl. No.: 12/288,621

(22) Filed: Oct. 22, 2008

(30) Foreign Application Priority Data
Jul. 9, 2008 (HK) 08107520.6

(51) Int. Cl. F21L 4/00

(52) U.S. Cl. 362/208

(57) ABSTRACT

A toy flashlight includes a body for housing a battery, a light source powered by the battery, a translucent head attached to or formed integrally with the body and into which light from the light source is directed to illuminate the head to give a glowing effect. The head and body are of a foam plastics material that is safe for children.

### BACKGROUND OF THE INVENTION

The present invention relates to a toy flashlight or “torch”. The invention more particularly, although not exclusively, relates to a toy flashlight for young children with which a strong beam of light cannot be directed at the eyes.

Flashlights or torches can of course be used by small children as toys. However, standard flashlights can emit bright light which can be misdirected—particularly at the eyes. Standard flashlights are generally made of hard metallic or plastics material which renders them susceptible to damage if dropped by children on hard surfaces.

### OBJECTS OF THE INVENTION

It is the object of the present invention to overcome or substantially ameliorate at least one of the above disadvantages and/or more generally to provide an improved toy flashlight.

### DISCLOSURE OF THE INVENTION

There is disclosed herein a toy flashlight comprising:

a body for housing a battery;

a light source powered by the battery;

a translucent head attached to or formed integrally with the body and into which light from the light source is directed to illuminate the head;

wherein the head and body are of a child-safe material as defined herein.

Preferably, the head includes a translucent cover upon which light from the light source impinges to illuminate the cover.

Preferably, the child-safe material of the head and body comprises foam plastics.

Preferably, the cover is formed integrally with the head.

Preferably, the head is formed integrally with the body.

Preferably, the light source comprises an LED.

Preferably, the head includes a cavity through which light from the light source passes and impinges upon the cover.

### DEFINITION

As used herein, the phrase “child-safe material” is intended to encompass materials which are not so hard as to be likely to inflict or sustain damage when dropped upon a hard surface. High impact strength materials which are also relatively soft and resilient are intended. Polystyrene is envisaged and perhaps also expanded polyethylene, but any relatively lightweight self-supportive and soft resilient material of sufficient impact strength is intended. Excluded from the definition are hard plastics materials such as polycarbonate.

### BRIEF DESCRIPTION OF THE DRAWINGS

A preferred form of the present invention will now be described by way of example with reference to the accompanying drawings, wherein:

FIG. 1 is a schematic side elevation of a toy flashlight; and

FIG. 2 is a schematic top elevation of the toy flashlight of FIG. 1 showing internal detail.

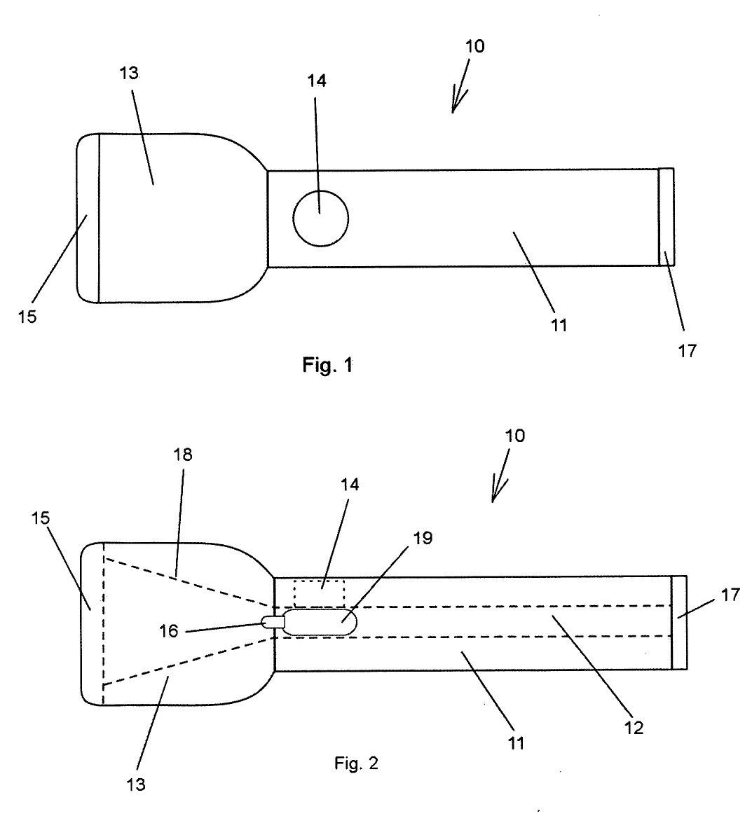

### DESCRIPTION OF THE PREFERRED EMBODIMENT

In the accompanying drawings there is depicted schematically a flashlight 10 comprising an elongate body 11 which houses one or more batteries in a battery compartment 12. The body 11 is typically formed as a polystyrene moulding but could be formed of any relatively soft and resilient material that is safe to young children. An end cap 17 can be formed integrally with the body 11 in a toy flashlight intended for disposal after battery-depletion, or might be detachable to gain access to the battery compartment. The end cap 17 would typically be formed of the same soft resilient material as that from which the body 11 is formed.

A pushbutton 14 is positioned upon the body 11 and activates a switch 19 to which there is attached an LED 16.

A head 13 is of translucent material and is formed integrally with the body 11 and includes a hollow cavity 18 which serves to minimise the wall-thickness of the head 13. At the front of the head, there is provided a translucent cover 15 which would typically be formed integrally with the head 18 or formed as a separate attachment. Typically, the body 11, head 13 and cover 15 would be an integral moulding of child-safe translucent material.

Upon activation of the pushbutton 14, switch 19 completes a circuit between any batteries in battery compartment 12 and the LED 16 to illuminate the cover 15 from behind and also illuminate the head 13. As the cover 15 and head 13 are translucent, they will appear to glow, but the flashlight will not actually emit a strong beam of light suitable for illuminating a remote surface for example. The light from the LED which impinges upon the cover 15 (and head 13) is conveyed through the polystyrene (or other suitable) material back through the head and could even illuminate the body 11 so that the whole flashlight or at least a substantial portion of it appears to glow from inside. The glow is intended to be particularly effective under dim light conditions such as at night time.

It should be appreciated that modifications and alterations obvious to those skilled in the art are not to be considered as beyond the scope of the present invention. For example, the head 13 could be formed of a material having a colour that is different to that of the body. Furthermore, the LED may be of any available colour or might indeed be a multi-coloured LED capable of changing colour in sequence for example. Where the head/cover is of white polystyrene for example, then it could appear to glow in different colours. As a further alternative, rather than forming the body and head 13 solely of resilient material such as polystyrene, these parts could be formed with an inner frame or former of rigid material defining the basic shape of the body and head and be provided with a polystyrene (or other material) outer shell which might be moulded integrally with cover 15 over the inner former. As yet a further alternative, the light source could be an incandescent bulb instead of an LED.

1. A toy flashlight comprising:
a body for housing a battery;
a light source powered by the battery;
a translucent head attached to or formed integrally with the body and into which light from the light source is directed to illuminate the head;
wherein the head and body are of a child-safe material as defined herein.

2. The toy flashlight of claim 1, wherein the head includes a translucent cover upon which light from the light source impinges to illuminate the cover.

3. The toy flashlight of claim 1, wherein the child-safe material of the head and body comprises foam plastics.

4. The toy flashlight of claim 2, wherein the cover is formed integrally with the head.

5. The toy flashlight of claim 4, wherein the head is formed integrally with the body.

6. The toy flashlight of claim 1, wherein the light source comprises an LED.

7. The toy flashlight of claim 2, wherein the head includes a cavity through which light from the light source passes and impinges on the cover.
